(19) United States
(12) Patent Application Publication
(10) Pub. No.: US 2004/0044481 A1
(43) Pub. Date: Mar. 4, 2004

(54) Method for protein identification using mass spectrometry data

(76) Inventor: Benjamin R. Halpern, San Jose, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/241,751

(22) Filed: Sep. 9, 2002

Related U.S. Application Data
(60) Provisional application No. 60/384,876, filed on May 31, 2002.

(51) Int. Cl. G06F 19/00

(52) U.S. Cl. 702/19; 702/20

(57) ABSTRACT

The present teachings describe methods for matching a query peptide to a database of known peptides based on a mass analysis approach. The methods described herein facilitate rapid, sensitive, and selective identification of an unknown query peptide and provide the ability to develop applications which perform substantially automated high throughput protein identification. The methods described herein also allow for mass spectrometry data for a query peptide to be categorized and weighted according to its quality. Furthermore, the methods described herein provide robust identification of modified query proteins by either anticipating modifications or adjusting for modified peptide masses.

### CLAIM OF PRIORITY

This U.S. patent application claims priority to U.S. Provisional Application No. 60/384,876 entitled “Method of Large Scale Protein Matching Using Directed Molecular Weight Zone Discrimination” filed May 31, 2002 and U.S. Patent Application No. 10/087,541 entitled “Methods for large scale protein matching” filed Mar. 1, 2002 and International Application Number PCT/US02/06685 entitled “Methods for large scale protein matching” filed Mar. 5, 2002 each of which are hereby incorporated by reference in their entirety.

### BACKGROUND

1. Field

The present teachings generally relate to proteomic analysis, and more particularly to techniques for automated mass spectrometry protein analysis.

2. Description of Related Art

Tandem mass spectrometry (“MS/MS”) techniques have been proven for analyzing peptides. In tandem mass spectrometry, the peptide to be analyzed is introduced into a first mass spectrometer which serves to select, from a mixture of peptides, a target peptide of a particular mass or molecular weight. The target peptide is then fragmented to produce a mixture comprising the intact peptide and various component fragment peptides of smaller mass. This mixture is then resolved with a second mass spectrometer which generates a fragment spectrum from which mass/charge ratios for detected fragments can be used to identify the target peptide.

In conventional approaches to peptide analysis, difficulties may arise as large amounts of information must be carefully evaluated to resolve the composition of the target peptide. These methods are often labor intensive and necessitate evaluation by a skilled researcher or operator. In the case of high throughput analysis, involving many hundreds, if not thousands, of target peptides non-automated methods of peptide analysis rapidly become impractical to apply. Thus, there is a need for a method for peptide analysis that provides the ability to perform peptide identification functions in a high-throughput environment with an acceptable degree of sensitivity and selectivity. The method should further provide the ability to incorporate and resolve existing peptide information such as that found in public and private databases. Furthermore, the method should be adaptable for use in the identification of unknown peptide compositions.

### BRIEF SUMMARY OF THE INVENTION

A detailed description of each of these elements and the operation of the method is provided below. All references cited herein are incorporated by reference in their entirety.

In one aspect, the present teachings relate to a method for comparing a query peptide to a plurality of database peptides using mass spectrometry data from the query peptide and a pre-calculated peptide index.

In another aspect, the present teachings relate to a method for increasing sensitivity and selectivity in the identification of peptides from their mass spectrometry fragmentation spectra by identifying the various categories of hits and optimizing a set of weights assigned to these categories.

In another aspect, the present teachings relate to a method for minimizing the deleterious effect of a modification of a query peptide when comparing the modified query peptide to a plurality of database peptides.

In another aspect, the present teachings relate to a method for utilizing the mass information of a known modification of a query peptide to enhance the quality of identification.

In another aspect, the present teachings relate to a method for increasing the speed of identification of a modified query peptide by comparing the modified query peptide to a plurality of database peptides augmented by a plurality of modified database peptides.

In still another aspect, the present teachings relate to a method for determining the identity of a query peptide using a plurality of database peptides. The method further comprising the steps of: (a) constructing an index table comprising a plurality of peptide mass values using masses obtained from the plurality of database peptides and backbone ion fragments thereof, (b) identifying a plurality of query mass values associated with the query peptide and one or more query peptide backbone fragments or ions; (c) identifying query mass values that correspond to masses contained in the index table and generating a plurality of comparison scores which reflect the correspondence between the query mass values and the masses contained in the index table; and (d) evaluating the comparison scores to identify at least one database peptide related to the query peptide based upon the greatest comparison score.

In yet another aspect, the present teachings relate to a method for comparing a query peptide to a plurality of database peptides. The method further comprising the steps of: (a) constructing an index table comprising a plurality of mass values for the database peptides and ion fragments thereof; (b) identifying a plurality of mass values associated with the query peptide and peptide fragments thereof; (c) comparing the plurality of mass values associated with the query peptide and peptide fragments thereof with the plurality of mass values for the database peptides and ion fragments thereof and assigning a mass score to each of the mass values associated with the query peptide based upon the similarity between the compared mass values; and (d) evaluating the mass scores to identify at least one comparison having the greatest mass score and associating the query peptide with the database peptide which resulted from the at least one comparison having the greatest mass score.

In still another aspect, the present teachings comprise a method for comparing a modified query peptide to a plurality of database peptides, the method further comprising: (a) generating a plurality of query mass values for the query peptide; (b) generating a plurality of database mass values associated with the plurality of database peptides; (c) identifying a modified set of query mass values from the plurality of query mass values wherein the modified set of query mass values correspond to mass values that reflect a modification to the query peptide; (d) excluding the modified set of query mass values from the plurality of query mass values, and (e) performing a comparison search which compares the plurality of query mass values to the plurality of database mass values to thereby associate the query peptide with at least one database peptide.

In another embodiment the present teachings comprise a method for comparing a modified query peptide to a plurality of database peptides, the method comprising: (a) generating a plurality of query mass values for the query peptide; (b) generating a plurality of database mass values associated with the plurality of database peptides; (c) identifying a modified set of query mass values from the plurality of query mass values wherein the modified set of query mass values correspond to mass values that reflect a modification to the query peptide; (d) adjusting the plurality of query mass values associated with the modified set of query mass values to account for mass differences resulting from the modification to the query peptide, and (e) performing a comparison search which compares the plurality of adjusted query mass values to the plurality of database mass values to thereby associate the query peptide with at least one database peptide.

In still another embodiment the present teachings comprise a method for comparing a query peptide to a plurality of database peptides, the method comprising: (a) constructing an index table comprising a plurality of database mass values associated with fragmentation spectra for the database peptides; (b) identifying a plurality of query mass values associated with a fragmentation spectrum for the query peptide; (c) identifying at least one modification associated with at least one of the plurality of query mass values; (d) compensating for the at least one modification associated with at least one of the plurality of query mass values thereby generating a plurality of compensated query mass values; (e) performing a search of the index table using the compensated query mass values and (f) identifying the composition of the query peptide based on similarities between the compensated query mass values and the database mass values.

### BRIEF DESCRIPTION OF THE DRAWINGS

FIG. 1 is a diagram illustrating an overview of a peptide data preparation method for use in peptide identification and analysis.

FIG. 2A is an exemplary fragmentation spectrum illustrating range selection and peak identification.

FIG. 2B is an exemplary peptide from which complementary ion fragments are formed.

FIG. 3 illustrates an exemplary method for generating a peptide index table.

FIG. 4 illustrates one embodiment of a peptide mass search method.

FIG. 5 illustrates another embodiment of a peptide mass search method.

FIG. 6 illustrates one embodiment of a zone modification procedure for peptide analysis.

FIG. 7 illustrates exemplary MS/MS spectra for an experimentally derived peptide and a theoretical or known peptide.

FIG. 8 illustrates an exemplary functionality for peptide modification designation in the analysis of peptide or protein samples embedded within a software program or application.

### DETAILED DESCRIPTION OF CERTAIN EMBODIMENTS

Definitions

For the purposes of the present teachings, “peptide” refers to a sequence of amino acids. A “peptide database” refers to a list or collection of peptide information. It will be appreciated that the peptide database may be implemented in numerous different manners including, for example, a spreadsheet, a relational database, or other suitable data structure that may be used to store and associate information. A “peptide index” refers to information used for locating a selected peptide in the peptide database. In various embodiments, the peptide index comprises an offset value from which the selected peptide may be located relative to a selected position within the database (e.g. the beginning/end of the database).

For the purposes of the present teachings, an “initial string” of a peptide refers to a subsequence comprising one or more peptides commencing at a first end of the peptide (e.g. the peptide's first amino acid). Similarly, a “terminal string” of a peptide refers to a subsequence comprising one or more peptides commencing at a second end of the peptide (e.g. the peptide's last amino acid). Both the initial string and terminal string may comprise the entire peptide or a portion thereof. Peptide fragmentation in accordance with mass spectrometry analysis may result in N-terminal peptide cleavage fragments having a retained charge. These cleavage fragments are referred to as a “b-ions”. Similarly, peptide fragments comprising C-terminal cleavage fragments having retained charges are labeled a “y-ions”. In various embodiments, masses for b-ions may be calculated by summing the amino acid masses contained in the cleavage fragment and adding the mass of a proton. Masses for y-ions may be calculated by summing the masses of the amino acids contained in the cleavage fragment and adding the mass of water and a proton.

For the purposes of the present teachings, the mass of a peptide may be defined as the sum of the masses of its constituent amino acids. The set of “initial masses” of a peptide comprises the collection of masses of some or all of the possible subsequences associated with the initial strings of the peptide. Similarly, the set of “terminal masses” of a peptide comprises the masses of some or all of the possible subsequences associated with terminal strings of the peptide. The set of “associated masses” of a peptide comprises a partial or complete union of the set of initial masses and the set of terminal masses.

Except as otherwise noted, the terms “mass,” “mass ratio” and “mass/charge ratio” are used interchangeably for the purposes of the present teachings. The set of “predicted mass ratios” of a peptide is the set of mass/charge values expected or predicted to result from performing a mass spectrometry measurement on a sample peptide.

For the purposes of the present teachings, the “index table” comprises a data structure comprising discrete mass values associated with one or more peptides. The “allowed values” of an index table refers to a range of permitted or desired values for the table's index. It will be appreciated that the data structure associated with the index table may be implemented in numerous different manners including for example, a spreadsheet, a database, or other suitable data structure that may be used to store and associate information. In various embodiments, the index table may comprise various fields and information associated with a peptide database containing information describing a plurality of different peptides which may further include mass spectrometry fragmentation spectrum.

For the purposes of the present teachings, a “query peptide” refers to a peptide used to interrogate the peptide database. A “query spectrum” is a representative mass spectrometry fragmentation spectrum for the query peptide comprising a plurality of mass/charge values. In various embodiments, the query spectrum need not include any intensity values from the mass spectrometry data. The set of “query masses” and “query mass ratios” refer to sets of masses obtained from the query spectrum. The subset of “primary query masses” and “primary query mass ratios” comprise those obtained from information contained in the fragmentation spectrum. In various embodiments, the subset of “complementary query masses” and “complementary query mass ratios” comprise those calculated by subtracting the primary query masses from the mass of the full query peptide.

For the purposes of the present teachings, a “hit” may be representative of a peptide index located at a selected mass value contained in the index table, wherein the difference between selected mass value and a query mass resides above, below, or within a defined tolerance value.

For the purposes of the present teachings, a “peak mass ratio” is a query mass ratio adjusted by a measured mass/charge ratio to account for putative isotope patterns and/or charge. The “spectral range” of a peptide may range from zero to the molecular weight of the doubly-charged parent peptide or peptide ion.

For the purposes of the present teachings, a “modification” may reflect a change in the mass ratio of a peptide, either by one or more of its amino acids being changed or having a particular composition; or by its N-terminal or C-terminal group being altered or having a particular composition. It will be appreciated by one of skill in the art that an amino acid may be modified in a number of ways including, but not limited to; phosphorylation, glycosylation, addition or removal of a selected functional group, or replacement with a different amino acid. The “location(s)” of a modification represents the location(s) of the modified amino acid.

For the purposes of the present teachings, the “difference mass” of a modified query peptide refers to the difference between the molecular weight of a modified query peptide and the molecular weight of an unmodified query peptide. For example, if the modification were a phosphorylation, the difference mass would be the mass of the phosphoryl group. The “modification mass ratio” refers to the mass/charge ratio of the modified subspecies of a modified peptide (e.g. the first b-ion).

Overview

In various embodiments, the present teachings describe a system and methods for protein or peptide identification using mass spectrometry data and information. As will be described in greater detail hereinbelow, tandem mass spectrometry (MS/MS) data, fragmentation spectra and other information for each sample may be compared against previously identified or reference information to provide a means for resolving the composition of the sample. Sequence resolution according to the present teachings may further be used in the identification and characterization of both known and unknown protein and peptide compositions. Additionally, the disclosed methods are useful in resolving protein compositions wherein one or more modifications may be present within proteins or peptides contained in the sample. This feature provides the ability to account for and accommodate a wide range of potential modifications thereby aiding in discerning the underlying sequence of the protein or peptide sample undergoing analysis.

One limitation typically encountered in conventional methods is that due to the relatively large quantity or volume of information contained in a MS/MS spectrum, only a limited number of peptides (often as little as one) from the protein sample can be analyzed during a given analysis. Peptide analysis can also be significantly hindered in conventional approaches by the presence of peptide modifications unless some prior knowledge of the modification is known or presumed. In various embodiments, the present teachings provide improvements in peptide and protein identification through the use of an error-tolerant and modification-tolerant approach. This methodology is based, in part, upon specification of a “modification” mass. The modification mass may be added or subtracted from the calculated peptide molecular weight to reflect the presence of modifications which may affect overall molecular weight of the peptide. Taking into account the effect on molecular weight various peptide modifications may have improves the ability to identify query peptides when evaluating them against the database of reference peptide information which may not contain a peptide with an identical modification.

The query peptide modification may be due to specific chemical modifications, amino acid substitutions (e.g. homologous peptides), truncations, non-specific or missed cleavages, or virtually any other modification that results in the experimental mass of the peptide or protein of interest differing from an expected or previously identified mass. In one aspect, the method may return a calculated modification mass and an identification of the approximate region or “zone” of the peptide where the modification may be localized. These functions are desirably performed in such a manner so that prior knowledge of the modification is not necessarily required thereby improving the flexibility and potential utility of protein analysis.

Data Preparation

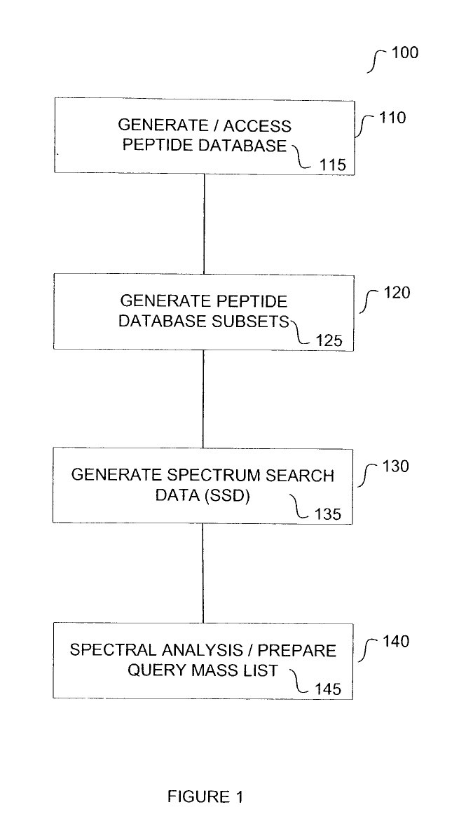

FIG. 1 illustrates an overview of a peptide data preparation method 100 in accordance with the present teachings. The method 100 commences in state 110 with the generation or accessing of a protein database 115. In various embodiments, the protein database 115 comprises a collection of stored information for a plurality of proteins or peptides that will be compared against a protein or peptide sample of interest (e.g. query peptide). In general, the protein database 115 desirably comprises amino-acid sequence information, mass spectrum information and/or fragmentation spectrums which serve as a reference for subsequent analysis as will be described in greater detail hereinbelow.

In one aspect, information contained in the protein database 115 is generated using protein and/or nucleotide sequence information and may further comprise genetic and spectral information describing prokaryotic organisms, eukaryotic organisms, virus, and other organisms and may be customized to specific organisms, cells, and/or tissues of interest. Additionally, the information from which the protein database 115 is formed may be derived from full-length protein or nucleotide sequence information, expressed sequence tags (EST), partial protein or nucleotide sequence information, and other sources of genetic information.

In one aspect, the protein database 115 may be populated using publicly available information as well as private or institutional sources of information in addition to other sources of genetic information. The publicly available information may comprise mass spectrum or fragmentation information and sequence information obtained from publicly accessible databases including, for example: NIST 98 (NIST/EPA/NIH Mass Spectral Library), GenBank, SwissProt, Ribosomal Database Project (RDP), Entrez, the DNA DataBank of Japan (DDBJ), the European Molecular Biology Laboratory (EMBL) and other repositories of genetic information. Institutional sources of information may include private/commercial databases, laboratory derived/experimental genetic information, sequencing/mapping data and other sources of genetic information.

In one aspect, the protein database 115 contains protein, peptide, or amino acid sequence information obtained from the complete gene or protein sequences (or as compete as is practically obtainable or available) for one or more organisms for which sequences and spectral information can be obtained from the public and institutional sources of information. Included in the protein database 115 may be the derived protein or peptide sequences and spectral information obtained from gene sequences or genetic information for a selected or target organism from which protein sequence evaluation against a protein or peptide sample will be desirably conducted.

Once the information to be contained in the protein database 115 is identified and collected in state 110, the method 100 proceeds to state 120 where one or more peptide database subsets 125 may be formed. In various embodiments, the database subsets 125 may be characterized by a peptide mass range which may reside between approximately zero daltons through the total mass of the protein or peptide sample. In one aspect, the number of database subsets 125 is selected based upon the approximate size of the parent protein database 115. In instances where the protein database 115 contains information describing many reference peptides it may be desirable to create an increased number of database subsets 125 so as to facilitate subsequent searching and analysis. Although it will be appreciated that the size and number of database subsets 125 is variable, an exemplary mass range for each database subsets 125 may be between approximately 5-500 daltons. Additionally, a query peptide mass range may be identified in conjunction with the database subset mass range thereby resulting in a finite database subset number. Thus, if a query peptide mass range of 20 daltons is selected and a database subset mass range is selected to be between 400 daltons and 3000 daltons, then the number of database subsets would be approximately 130.

In various embodiments, the organization of the peptide database 115 and associated database subsets 125 may comprise a collection or array of peptide masses, a collection or array of positions within the protein database 115 designating corresponding proteins which reside in the database 115, and a collection or array of the peptide positions which are associated with selected proteins. Thus, for a selected database 115 or database subset 125, a selected peptide index may provide sufficient information to identify a particular peptide along with its parent protein within the protein database 115.

It will be appreciated that various data structures and logical organizations of data may be used to relate the information contained in the databases 115, 125. For example, it is conceived that the databases 115, 125 may be implemented using applications designed for relational database development and implementation, such as, for example, those sold by Oracle Corporation or Sybase Corporation. Using the aforementioned database development software packages, the databases 115, 125 may be implemented using a dedicated database language, such as, structured query language (SQL). The structured query language is a language standardized by the International Standards Organization (ISO) for defining, updating and querying a relational database. In one aspect, the SQL coded database design desirably provides the developers of the databases 115, 125 with a highly refined instruction set with properties of reduced maintenance requirements and increased scalability.

In another aspect, the databases 115, 125 may comprise a database design implemented using numerous other programming languages such as, for example, JAVA, C/C++, Basic, Fortran, or the like, wherein the database structure, tables, and associations are defined by code of the programming languages. It is recognized however, that these languages may also be used to develop applications and programs used to access or manipulate the aforementioned SQL coded database design. For example, in one embodiment, the SQL coded database may interact with various accessory programs or servlets developed in other programming languages which provide graphical user interfaces to store, retrieve, and process the information of the database 115, 125.

It is further recognized that other relational databases may be used and/or other types of databases may be used, such as, for example, object oriented databases, flat file databases, and so forth. Furthermore, the databases 115, 125 may be implemented as a single database with separate tables or as other data structures that are well known in the art such as linked lists, binary trees, and so forth. Additionally, the databases 115, 125 may be implemented as a plurality of databases which are collectively administered.

It will be appreciated by those of skill in the art, that in the aforementioned database designs, the structure and schema of the database 115, 125 may be altered, as needed, to implement the relations or associations used to organize and categorize the information contained in the databases 115, 125. Additionally, the database schema may be altered for numerous reasons, such as, for example, to accommodate new data types, change existing data structures representing existing data types, modify relations between existing data structures, and add new databases to the databases 115, 125.

Following preparation of the database subsets 125 (if required or desired) in state 120, the method 100 proceeds to state 130 where one or more spectrum search data (SSD) 135 are prepared using the information contained in the databases 115, 125. Each SSD 135 may contain selected header information including a list of blocks, one for each peptide database subset 125. Each block comprises peptide data from the database 115 together with index information which references the peptides in their corresponding peptide database subsets 125.

In various embodiments, each block further comprises a pair of data structures designed to provide improved searching performance based, in part, upon fragment-ion masses. As will be described in greater detail hereinbelow, these data structures use index values to reference selected peptides that are mapped to the corresponding peptide databases in which information describing characteristics of the peptide are stored.

In one aspect, a peptide may be conceptualized as having two sets of associated masses. These masses reflect the masses of one or more subsequences starting from the two protein or peptide termini (e.g. the carboxyl termini and the amino termini). These masses may be used to generate a subset of theoretical masses of ions (b-series and y-series) produced by fragmentation during mass spectral analysis. In various embodiments, a fragment-ion mass range of interest may be specified for each of the two peptide termini to generate a subset of ions resulting from fragmentation of the peptide. These subsets of ions may further be divided into discrete bins or sub-subsets to further partition the total number of identified ions into discrete quantities of information. For example, the fragment-ion mass range for a hypothetical query peptide may be selected to reside between zero and 3000 daltons. Furthermore, a bin size of 0.01 daltons may be specified thereby resulting in division of the subsequences of the peptide into approximately 300000 bins.

Associated with each bin is an array or other data structure containing peptide indices. The indices in the array or data structure for a selected bin are those of peptides having an associated mass falling within that bin. A certain degree of tolerance may also be associated with the mass range for a selected bin providing flexibility in bin assignment and overlap between adjacent bins. In one aspect, the aforementioned array or data structure containing peptide indices provides for convenient accessibility to each of the peptides in a selected peptide database 115 that may give rise to a fragment ion of a selected or desired type within a particular mass range.

Following preparation of the spectrum search data (SSD) 135 in state 130, the method 100 proceeds to state 140 where a query mass list 145 is prepared. In various embodiments, the query mass list 145 represents a collection or list of singly-charged fragment ion monoisotopic masses associated with the query peptide having a mass Mₚ. The fragment ion masses may be identified as the mass for the query peptide is generally known and may be obtained for example by analyzing the experimental fragmentation spectrum or data for the query peptide. In one aspect, identification of the fragment ion masses is performed by searching for isotopic peak patterns within the fragmentation spectrum from which charge assignments may be made.

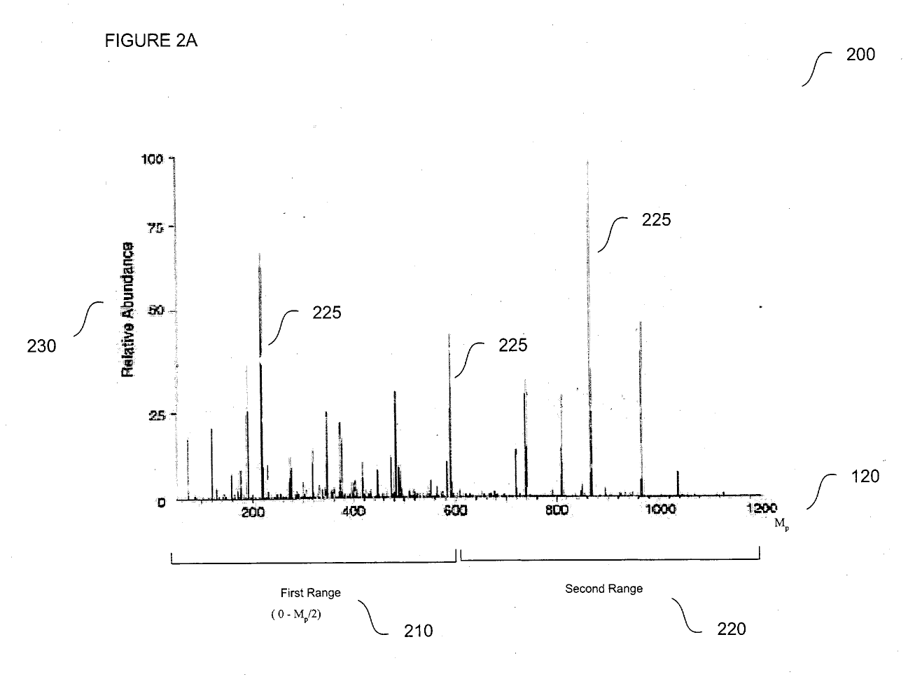

As shown in FIG. 2A an exemplary approach to fragmentation spectrum analysis comprises dividing a query peptide spectrum 200 into a first range 210 and a second range 220. The first range 210 may be specified as the masses contained in approximately the first half of the associated query peptide mass (0−Mₚ/2) with the second range 220 specified as the masses contained in approximately the second half of the associated query peptide mass (Mₚ/2−Mₚ). For each spectral range 210, 220, one or more peaks 225 representing individual peptide ions may be selected on the basis of relative intensity or abundance 230. As illustrated in FIG. 2B for singly-charged ions, the primary monoisotopic mass for the peptide ion 250 may be added to the query mass list 145 whereas for other charge states the corresponding mass for the peptide ion may be calculated and added to the query mass list 145. Subsequently, for each peptide ion mass, M_{f}, a complementary mass 260 may be calculated according to the equation:

Mₚ+2M_{H}−M_{f} Equation 1

In this equation, Mₚ represents the query peptide mass 270, M_{H} represents the mass of hydrogen, and M_{f} represent the primary peptide ion mass 250. The complementary mass 260 of the query peptide may then be added to the query mass list 145. In applying this approach, the masses of complementary singly-charged peptide ions 250, 260 (e.g. b-ion and corresponding y-ion) resulting from a query peptide 270 may be determined. This approach may be applied for virtually any N-residue peptide wherein the ion b(i) is complimentary to the ion y(N−1).

It will be appreciated that the aforementioned approach to query mass list generation and charge assignment based on fragmentation spectrum division may be readily modified as needed or desired. For example, it is conceived that the aforementioned mass ranges need not necessarily be selected in the exact manner as described and that the number of peaks selected from within each mass range may be variable in nature. Thus, modifications in the approach to spectral analysis 140 which associate a fragmentation spectrum 200 with one or more peptide masses 210, 220 and a query mass list 145 should be considered but other embodiments of the present teachings.

Search Methodology

In various embodiments, the search methods of the present teachings utilize a peptide mass index table. The index table is indexed by mass in discrete increments within a range of allowed values. For example, an index table could contain the values from 0.01 to 30,000 daltons, in increments of 0.01 dalton, resulting in a 3,000,000-row table.

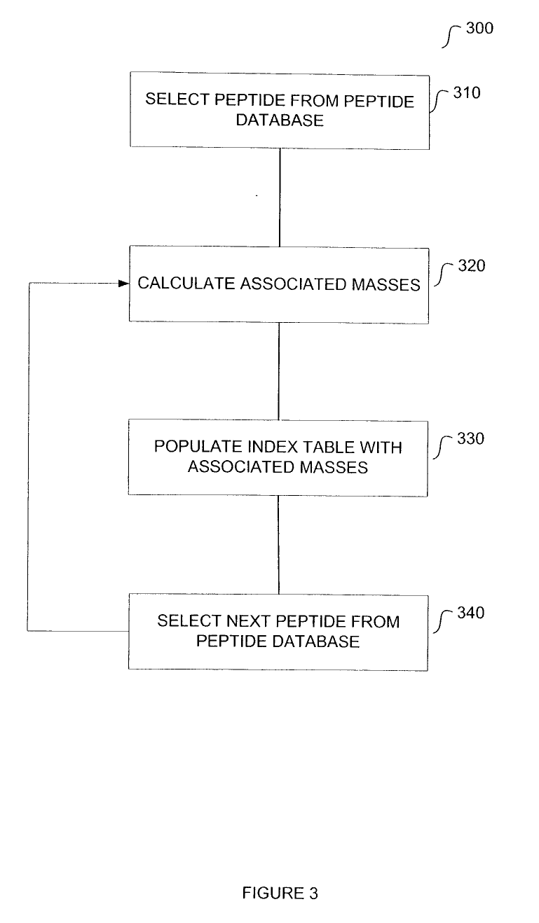

FIG. 3 illustrates an exemplary method 300 for generating the aforementioned index table. In one aspect, the method 300 commences in state 310 by selecting a query peptide from the protein database 115 or the database subsets 125. Subsequently, in state 320 the set of associated masses corresponding to the various ion compositions and fragments for the query peptide are determined according to the principles described in FIGS. 1 and 2 above. In state 330, for each associated mass identified in state 320, a peptide index may be identified and stored in the index table corresponding to that mass. Thus, for an exemplary index table arranged in a stack comprising one or more rows, the peptide index for each associated mass may be stored in a row of the stack corresponding to the value of the peptide index. This process 300 may then be repeated, as necessary or desired, in state 340 by selecting a subsequent peptide from the peptide database 115 and returning to state 320 to perform a similar set of calculations and operations. Upon completion of the method 300, each of the peptides in the peptide database 115 that are to be desirably incorporated into the search are incorporated into the mass index table.

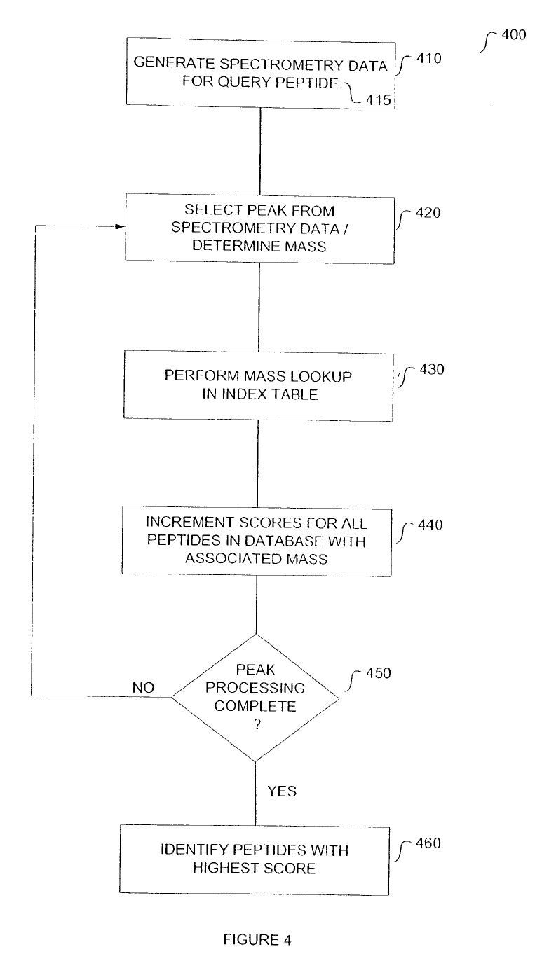

Referring to FIG. 4, a peptide mass search 400 involves comparing the set of query masses against a set of associated masses for one or more peptides in the peptide database 115. In one exemplary approach, the search 400 commences in state 410 where mass spectrometry data or fragmentation spectrum 200 for a query peptide 415 is collected. Using this information, the method 400 proceeds to state 420 where one or more peaks 225 from the spectrum 200 are identified and a determination of each peak's mass is made. Based on the identified masses, an index table lookup function is performed in state 430 to retrieve entries within the index table that correspond to the identified masses. In state 440, a scoring operation is performed wherein a plurality of mass scores maintained for one or more peptides in the database 115 are incremented based on the identification of retrieved entries within the index table having substantially the same associated mass. Subsequently, in state 450 the aforementioned operations may be repeated as necessary or desired.

The method 400 continues in state 450 wherein a determination is made as to whether all desired peaks in the spectrum have been processed. If additional peaks exist, the method 400 returns to state 420 where the next peak from the spectrum is selected and a mass evaluation is performed. Thereafter, similar mass lookups and peptide scoring proceeds as described above. These steps 420-450 are desirably repeated for one or more peaks within the spectrum and may be based upon identification of all peaks which reside above a selected threshold or alternatively a selected number of peaks may be processed for each fragmentation spectrum.

Finally, in state 460 those peptides with the greatest score (e.g. greatest number of hits) are identified. The number of peptides identified in this state 460 may be based upon selecting peptides with scores that reside above a selected score threshold or alternatively by identifying a selected number of peptides having the greatest scores from the collection of peptides contained in the peptide database 115.

It is possible to create an index table that is both efficient with respect to both memory and speed. In one embodiment, the index table may be calculated in two passes. In the first pass, the number of entries for each row is calculated. Based on the number of entries in each row, a sufficient amount of memory for that row may be allocated. In the second pass, the rows are populated with peptide indices referencing the peptides responsible for the associated masses corresponding to each row.

In various embodiments, a peptide mass search may be performed as follows: A score value is allocated and initialized for each peptide in the peptide database. For each query mass, the corresponding row in the index table is referenced, all of the peptide indices in the row are looked up, and all score values associated with those peptide indices are incremented.

A further embodiment employs a tolerance value for matching a query mass to a mass associated to a peptide in the peptide database. A query mass can be associated with an initial mass (e.g. an initial mass hit) if the difference between the query mass and the expected N-terminal mass of the associated initial string is within a selected tolerance quantity of the initial mass. Similarly, a query mass can be associated with a terminal mass (e.g. a terminal mass hit) if the difference between the query mass and the expected C-terminal mass of the associated terminal string is within a selected tolerance quantity of the terminal mass.

In the aforementioned embodiment, a search may be performed as follows: As in the previous example, a score value may be allocated and initialized for each peptide in the peptide database. However, in addition to referencing the row corresponding to the query mass, all neighboring rows within the specified tolerance may also be referenced. In a manner similar to the previous example, one or more of the peptide indices in one or more of the referenced rows may be looked up, and score values associated with those peptide indices may be incremented.

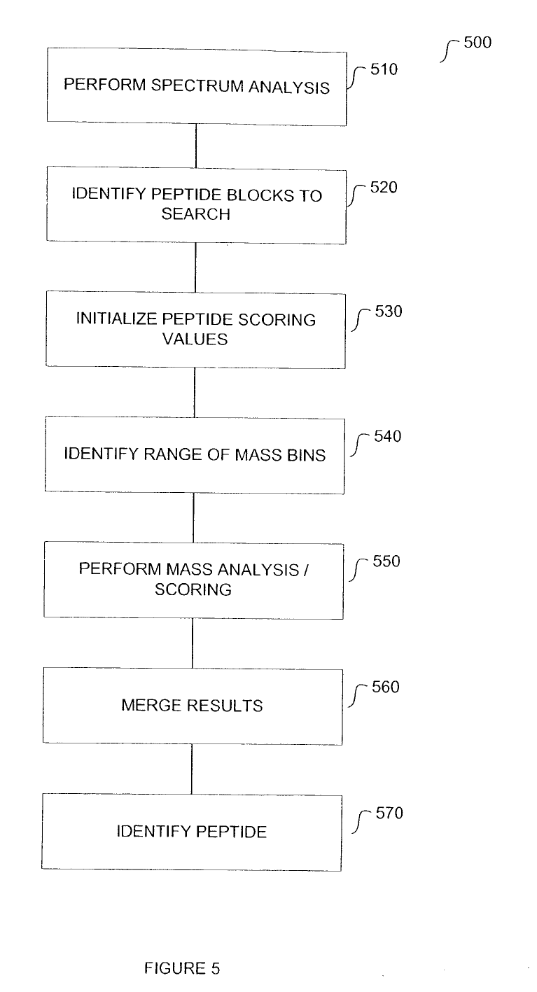

FIG. 5 illustrates another embodiment of the peptide mass search method 500 to be used in connection with the peptide data preparation method 100 described in FIG. 1. The search method 500 commences in state 510 where the mass spectrum information or fragmentation spectrum are analyzed as previously described. In state 520, for each spectrum, the experimentally determined or known mass of the peptide is used to determine which peptide blocks will need to be searched. Determination of which blocks to search desirably provides a means to improve search performance by identifying, in advance, all of the peptide spectra that may need to be searched and conducting this search once for each block.

In state 530, peptide scoring values are initialized. The peptide scoring values may be maintained in a data structure or array which facilitates subsequent evaluation of each of the scores relative to one another in subsequent steps of the method 500. Following scoring value initialization, the method 500 proceeds to state 540 where for each peptide block in the aforementioned SSD 135, if the current block is to be searched, then the peptide mass and query mass list are accessed. In state 550, a mass analysis and scoring function is performed wherein for each query mass, the range of mass bins is identified using a specified mass tolerance and the scoring value for each peptide is identified. If the mass of the peptide falls within the specified mass tolerance, then the scoring value associated with those mass bins is incremented. In state 560, the results of each search for a given spectrum may be combined where more than one block may be searched for each spectrum. Individual block results are further merged into a finalized collection of search results for each spectrum wherein a selected search result refers to a unique peptide. Thereafter, in state 570, the peptide with the greatest scoring values may be associated with the query peptide.

Weighted Search Method: Categories of Hits

In various embodiments, the search methodologies described above may employ a collection of one or more weighting factors directed towards the various categories or classes of peaks in the query spectrum. One rationale for this approach is that experimental data may indicate that some categories or classes of peaks may yield more predictive hits or useful identification than others. Peaks in the query spectrum may further be categorized by several criteria. One such criterion is the type of ion which produced the peak, such as a y-ion, b-ion, a-ion, or immonium ion. Another criterion may be whether the peak is a primary or complementary peak.

In mass spectrometry, a sample of a peptide may be fragmented into a plurality of subfragment ions, and the mass/charge ratios one or more of these ions are determined. Categories of subfragment ions are well known in the art, including y-ions, b-ions, a-ions, and immonium ions. For example, it has been observed that y-ions are about twice as common as b-ions in some common settings in common mass spectroscopy machines. Thus, the number of hits involving predicted y-ions may be more predictive than the number of hits involving predicted b-ions. Consequently, if the hits from those more predictive categories are weighted more heavily the ensuing query peptide identification may be of higher quality or confidence.

In various embodiments, a set or collection of ion types may be selected. (e.g. a set of singly-charged y-ions and b-ions). Subsequently, a set of one or more possible subfragment ions may be calculated for each peptide in the peptide database, the predicted mass/charge ratio is calculated for each subfragment ion, and the peptide index is populated according to the set of predicted mass/charge ratios as described in the section above.

In this embodiment, the query spectrum may be examined for peaks corresponding to ions of the selected set of ion types. The set of query mass ratios is determined by selecting those peaks believed to correspond to the selected set of ion types.

Sometimes the mass ratio of the peak itself represents a query mass ratio, as when the isotope pattern that this peak belongs to suggests that it has a single charge. When the isotope pattern suggests that the ion giving rise to the peak has a charge of 2, then its mass ratio multiplied by 2, minus the mass of hydrogen, may be used as a query mass ratio. Similarly, when the isotope pattern suggests other charges, the mass ratio of the peak is adjusted to the equivalent singly charged, mono-isotopic mass ratio before it is used as a query mass ratio.

Weighted Scoring Analysis

In various embodiments, the quality of data in a fragmentation spectrum can vary from peak to peak and searching a peptide database with data derived from a fragmentation spectrum may not produce matches or hits with sufficient specificity and sensitivity. In one embodiment, the present teachings categorize peaks from the fragmentation spectrum according to a perceived quality and assigns higher weights to higher quality peaks. For example, the quality of a peak can vary according to whether the peak represents a y-ion or a b-ion; specifically, since y-ions tend to be twice as prevalent as b-ions in common machines at common settings, it follows that the number of hits involving y-ions should be roughly twice as predictive as those of b-ions. In another example, the quality of a peak may also vary proportionally to its intensity.

In one embodiment, the weights that are assigned to each category of peak are calculated through the use of learning examples or training data. A learning example comprises a query spectrum for which the correct peptide is known. The weights assigned to the categories are adjusted and tuned on the learning examples so that the known answer among the database peptides is prominently featured from the possible combinations of categories.

As an illustrative example, suppose there are n peptides in the peptide database, that there are m categories of hits, that Hᵢⱼ is the number of hits in category j for peptide i, and that Wⱼ is the weighting value for category j. In this example, Xᵢ is the score for peptide i and is calculated as follows:

$${X}_{i} = {\sum }_{j} {W}_{j} * {H}_{i , j}$$

The average score, \overline{X}, is calculated as follows:

$$\overline{X} = \frac{1}{n} {\sum }_{i} {X}_{i}$$

The population variance, σ², for \overline{X} is calculated as follows:

$${σ}^{2} = ( \frac{1}{n} ) {\sum }_{i} {( {X}_{i} - \overline{X} )}^{2}$$

In a learning sample, the query peptide is known and is present in the peptide database at position q. Let X_{q} be the score calculated for the query peptide. Define the normal deviate, D, as follows:

$$D = \frac{{X}_{q} - \overline{X}}{σ}$$

A desirable set of weights is one that distinguishes the score for the correct match, in this case X_{q}, from all other scores. In this example, therefore, it may be desirable to set the weights to maximize D.

In one method for determining optimal weights, a covariance value C_{ab} is used. The value C_{ab} represents the covariance between categories a and b, and is calculated as follows:

$${C}_{a b} = ( \frac{1}{n} ) {\sum }_{i} ( {H}_{i a} - \overline{X} ) ( {H}_{i b} - \overline{X} )$$

It follows that the variance calculation described above can also be expressed in terms of the weights and the covariance:

$${σ}^{2} = {\sum }_{a = 1}^{m} {\sum }_{b = 1}^{m} {W}_{a} {W}_{b} {C}_{a b}$$

Taking the derivative with respect to a specific weight value Wₖ yields:

$$\frac{\partial {σ}^{2}}{\partial {W}_{k}} = 2 {\sum }_{b = 1}^{m} {W}_{b} {C}_{b k}$$

Similarly, the partial derivative of N² with respect to a specific weight value Wₖ can be expressed as:

$$\frac{\partial {N}^{2}}{\partial {W}_{k}} = \frac{{σ}^{2} 2 ( {X}_{q} - \overline{X} ) ( {H}_{q k} - {\overline{X}}_{k} ) - {( {X}_{q} - \overline{X} )}^{2} 2 {\sum }_{a = 1}^{m} {W}_{a} {C}_{a k}}{{( {σ}^{2} )}^{2}}$$

Setting this to zero, and simplifying by assuming that X_{q}≠\overline{X}, we get:

$${σ}^{2} ( {H}_{q k} - {\overline{X}}_{k} ) = ( {X}_{q} - \overline{X} ) {\sum }_{a = 1}^{m} {W}_{a} {C}_{a k}$$

Which can be re-cast as:

$${\sum }_{a = 1}^{m} {W}_{a} {C}_{a k} = \frac{{σ}^{2} ( {H}_{q k} - {\overline{X}}_{k} )}{( {X}_{q} - \overline{X} )}$$

Using vector and matrix notation, and defining the vector d such that:

dₐ=H_{qa}−\overline{X}ₐ

Then:

$$W C = ( \frac{{σ}^{2}}{{X}_{q} - \overline{X}} ) d$$

And thus:

$$W = ( \frac{{σ}^{2}}{{X}_{q} - \overline{X}} ) d {C}^{- 1}$$

This equation can be solved to yield an optimal set of weights for the learning example q.

The present teachings may also use a plurality or set of learning examples to determine a plurality or set of weights to use for subsequent unknown peptides. For each learning example, a set of optimal weights may be calculated and normalized such that the sum of their squares is approximately 1. Then the average over the set of learning examples of each of these normalized weights may be used in searches with new unknown peptides. A desirable set of weights are those which maximize the normal deviate.

Once a set of weights have been determined, the weights are employed in assaying unknown query spectra, having the reasonable hope that they improve identification of an unknown query peptide. In various embodiments, separate index tables are created for predicted mass ratios of different ion types. In alternative embodiments, separate index tables are created for primary and complementary mass ratios. In these embodiments, each index table may have a weight associated with it. During the search, score values are incremented. The score value for each index table is then multiplied by its weight. Finally, the score values for each peptide in the peptide database are summed across index tables.

In still other embodiments, separate index tables are created for separate, orthogonal criteria. For example, separate index tables can be created according to whether the query mass ratio represents a b-ion or a y-ion, and whether query mass ratio represents a peak mass ratio or a complement mass ratio. In this example, four separate index tables are created: one for b-ions, one for y-ions, one for peak mass ratios, and one for complement mass ratios. Comparing a query peptide to these tables results in four separate counts. Each count is then multiplied by the table's corresponding weight, and all weighted counts are summed to produce a weighted score for the query protein.

Effect of Peptide Modifications

Many peptides contain modifications such as post-translational modifications, including phosporylation and glycosylation. Other modifications include substitution of amino acids and changes in the N-terminal or C-terminal group of the peptide. Such modifications may change the peptide's mass, thereby resulting in difficulties in identifying the modified peptide through conventional mass analysis techniques. More specifically, such modifications may result in some of the ions of the query peptide being chemically different from the corresponding ions of the unmodified peptide. Hence some of the query mass ratios may not match their predicted mass ratios. When the location of the modification is unknown, then it is also unknown as to which ions and their measured mass/charge ratios have been affected by the modification. Experimental results indicate that in certain circumstances when there is a modification of an unknown query peptide, approximately half of the query peptide's mass ratios may be observed to not correspond to a predicted mass ratio for the correct peptide. That is, approximately half of the query masses of a modified query peptide may not be expected to distinguish the correct peptide from other peptides. These modified query masses are not only wasted, in that they do not contribute to the score of the correct database peptide, but they may actually be harmful, in that they increase the scores of incorrect database peptides. In one embodiment, the present teachings provide mechanism by which to identify modified query masses. One desirably benefit of this approach to peptide analysis is that it may improve the confidence or quality of the results.

In various embodiments, the difference between the molecular weight of the modified query peptide and that of the unmodified query peptide is called the “difference mass.” If the difference mass is not known, then the modified mass ratios in the query spectrum may be excluded from comparison. In the case where the difference mass is known, that information should be used to adjust the query mass ratios, thus increasing the selectivity and sensitivity of the search. In one embodiment, the query mass ratios are adjusted by subtracting the difference mass from them.

In various embodiments, the search method identifies the modified query masses of a modified query protein by dividing the spectral range of the query peptide into intervals. The range from zero to the doubly-charged parent ion query peptide's mass is referred to as the spectral range which may also be defined as the unmodified query peptide's mass. Given the mass of a query peptide, query mass ratios greater than the predicted mass may be ascribed to modification. In various embodiments, the spectral range may be divided into intervals, and separate searches are performed over each interval. In other embodiments, these modified query masses are excluded from comparison with the peptide index. In still other embodiments, these modified query masses may be adjusted before being used for comparison with the peptide index. Additional details of the manner of analysis which takes into account possible peptide modifications will be described in greater detail hereinbelow.

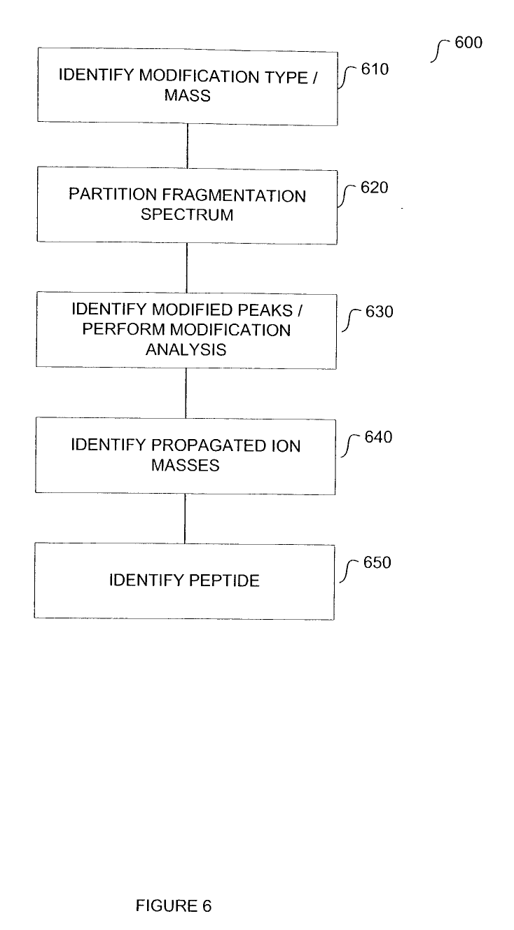

FIG. 6 illustrates one embodiment of a zone modification procedure 600 that may be used in conjunction with the present teachings. The zone modification procedure 600 commences in a state 610 where one or more possible peptide modifications are identified. These modifications may include: chemical modifications, amino acid substitutions, modification selected by mass, and other modification types that may affect the mass of the peptide when present. These modifications may be automatically selected based on knowledge of the type of modification present or expected within the peptide and may also include unknown modifications predicted to be contained within the peptide. As will be described in greater detail hereinbelow, peptide analysis software applications may be implemented to provide functionality to allow for user-selectable modification types and compositions which may be associated with the peptide(s) of interest.

In state 620 the fragmentation spectrum for a peptide may be divided into one or more zones. Each zone defines a discrete mass range in which a modification may be considered to be present within a selected peak in the zone. In state 630, for each zone, a separate mass search may be performed in which the mass of the modification is considered when comparing the query peptide fragmentation data and information to reference or theoretical peptide fragmentation data and information. During this analysis, one or more peaks or peptide masses may be associated with the modification. Subsequently, in state 650, peptide ion masses propagating from the modified peaks may be identified or flagged. In one aspect, peptide ion masses resulting from the modified peaks comprise b-ion and y-ion fragments derived from a parental modified peptide. Those peaks identified as having potential modifications present may be excluded from subsequent analysis thereby reducing erroneous or inaccurate peptide mass identification. Additionally, computations may be performed to determine the mass contribution resulting from the modification and this mass may be considered when evaluating the peaks of the fragmentation spectrum. In state 660, peptide identification is performed with knowledge of the modified peaks which may be handled in the aforementioned manners.

In various embodiments, by considering peptide modifications in a zone-oriented manner, it is possible to improve the quality and reliability on analysis. One rationale for this approach is that by reducing the number of peaks that might be discarded or otherwise not considered in the analysis, fragmentation data is preserved when possible and subsequently used in peptide identification. This manner of zone modification analysis may be readily integrated into existing software applications including peptide analysis programs such as Pro ID and Pro ICAT (Applied Biosystems, CA).

Furthermore, using the zone modification feature in peptide analysis and search methods may aid in the identification of unexpectedly modified peptides. The peptide analysis method may additionally identify the modification mass of the peptide as well as the amino acids on which the modification resides. Additional knowledge of the amino acids in the localized region can then be used to unambiguously identify the modification and its position.

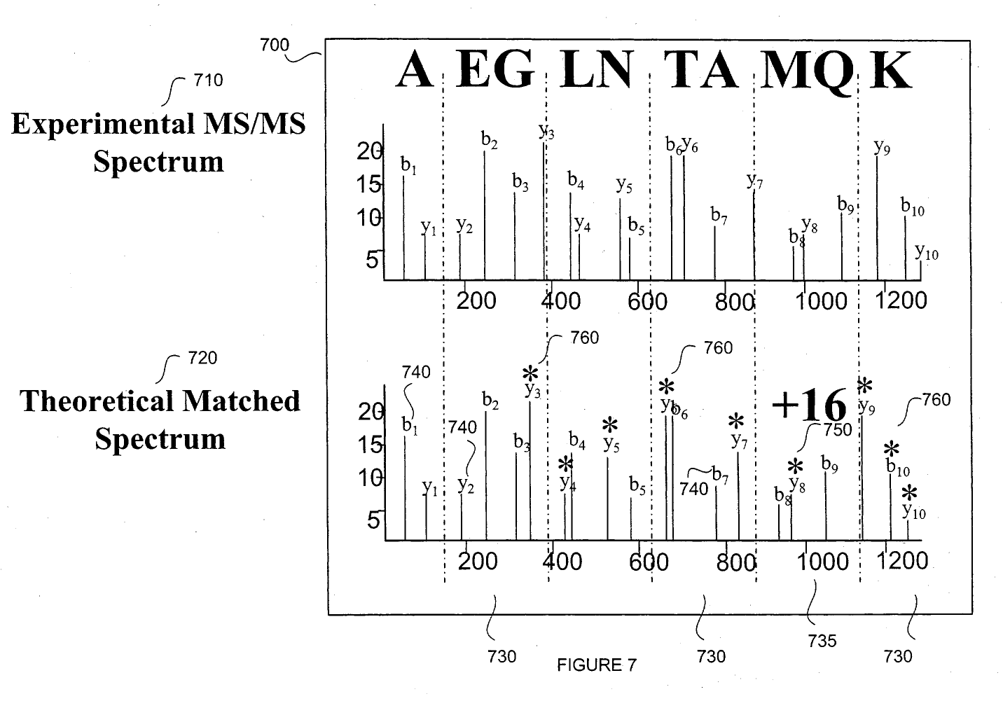

FIG. 7 illustrates exemplary MS/MS or fragmentation spectra for an experimentally derived peptide 710 and a theoretical matched spectrum 720. Each spectrum 710, 720 may be divided into a plurality of mass zones 730. In the illustrated embodiment, a modification is hypothesized or predicted to be associated with a peak 750 in zone 735. Based on the aforementioned analysis method 600, some or all of the b-ions and y-ions 760 propagating from the hypothesized modification 750 may be discarded or their mass considered in light of the modification. Peaks corresponding to other ions 740 in the zone 735 may be kept for analysis and other peaks 740 present in other zones 730 may also be kept. Additional details of various embodiments of the zone modification methodology follow in the subsequent discussion.

In various embodiments, the query peptide's spectral range may be divided into m substantially equivalent intervals. Consider one such interval from mass j to mass k, and assume that the modification mass ratio lies in the [j,k] interval. By assuming that the modification lies in the [j,k] interval, a set of modified query mass ratios may be identified. These identified mass ratios may then be dropped from comparison if the difference mass is unknown, or adjusted if the difference mass is known. Different sets of mass ratios can also be identified, for example, one mass ratio set can be identified by comparing the predicted b-ion mass ratios, and another set can be identified by comparing to predicted y-ion mass ratios. In one aspect, substantially all of the query mass ratios greater than k may be dropped or adjusted when looking for hits against predicted b-ion mass ratios. In another aspect, all of the query mass ratios greater than molecular weight +2H −j may be dropped or adjusted when looking for hits against predicted y-ion mass ratios. After the query peptide's spectral range may be divided into m intervals, a separate search is performed on each interval with each search assuming that the query peptide's modification lies in that search's interval. After performing the separate searches, the scores from each search may be combined, and the peptide with the greatest score over all of the searches is assigned as the best match to the query peptide.

In one aspect, peptide analysis in this manner increases the sensitivity and specificity of modified query protein searching by altering the distribution of hits in the search process. To better understand the advantages of identifying modified query mass ratios in the search process, it is helpful to examine the expected distribution of hits in a normal search where one interval may cover substantially the complete modified query peptide.

Suppose a query peptide is compared to a peptide database comprising k peptides. A histogram F may be constructed wherein F_{b} represents the number of database peptides receiving b hits. The fraction of peptides in the database receiving b hits, D_{b}, can be calculated as:

$${D}_{b} = \frac{{F}_{b}}{k}$$

If the search is defined as a number of trials wherein each query mass represents a trial, and if success is defined as the query mass hitting a peptide in the peptide index, then D (and F) can be seen to follow a binomial distribution. In one aspect, the variance of a binomial distribution is proportional to the number of trials; specifically the variance of the binomial distribution (n,p), where n is the number of trials and p is the probability of success per trial, is np(1−p). In other words, the variance of D (and F) is proportional to the number of query mass ratios used in the search. A desirable probability density of D (and F) represents a small number of sequences receiving a high number of hits, providing a sharp contrast between a true hit and noise. The binomial distribution approaches this ideal for lower values of n, especially for small values of p. Limiting a search to a short interval reduces the number of query mass ratios, or n, which in turn leads to a potentially more useful probability density function for D (and F).

In an illustrative example, two searches are performed and the results are used to calculate the histogram vectors H1 and H2. In this example, assuming that H1 and H2 are uncorrelated, it follows that H1 and H2 are random variables with the same density functions as F and D, above. Assuming that the first search comprises n query masses and the second search comprises 2n query masses; it follows that the variance of the H2 is twice that of H1. Therefore, because searching over a smaller interval reduces the number of query masses, interval searches have a smaller variance than searches over the entire peptide.

For larger peptide databases, that is, for increasing values of k, the difference becomes even more pronounced. Although the underlying density, D, remains constant, the raw values in the histogram F increases proportionally to k, resulting in a closer approximation to the desired binomial distribution. By dividing the peptide into m intervals and performing m searches, the size of the peptide database is effectively increased by a factor of m. Thus, in various embodiments the methods described herein may perform the dual purpose of designed a desirable probability density function for the results, as well as making the results correlate more closely to the desired function.

Experimental evidence indicates that when the number of intervals is selected within a range of approximately 4-8, acceptable results are generally obtained. The actual number of intervals need not necessarily be constrained this range however and thus more or less intervals may be used. Experimental evidence further indicates that when m is selected between a range of approximately 4-8 the advantage of eliminating modified query masses is significantly increased as is the advantage of adjusting modified query masses. In one embodiment, the number of query masses in an interval may be further reduced by identifying and eliminating modified query masses. For example, as illustrated above, if approximately half of the query masses are eliminated, the variance of the resulting distribution is approximately halved.

In other embodiments, the modified query masses may be identified and subsequently adjusted. In still other embodiments, the modified query masses may be adjusted by subtracting the known mass difference. Although the adjusted modified query masses may not necessarily be eliminated from comparison, their corresponding hits within the peptide database are more likely to be correct than if left unadjusted. This approach can be viewed as a way to approximately double the number of correct hits for a modified query protein.

Although the examples disclosed herein describe analysis of a singly-modified protein, one of ordinary skill in the art will readily appreciate how the aforementioned methods may be extended to analyze proteins containing two or more modifications. Thus analysis of peptides containing more than on modification using the aforementioned methods are conceived to be but other embodiments of the present teachings.

Adding Modified Peptides to the Peptide Database

In various embodiments, the present teachings provide a method for increasing the likelihood that an unknown modified query peptide will be correctly identified by adding appropriately modified peptides to the peptide database before proceeding with the construction of the index table.

It is well established in the art that many common modifications to peptides apply to certain amino acids. For example, generally serine, threonine, and tyrosine are receptive to phosphorylation. Similarly, cysteine and methionine are commonly oxidized. It is also well established in the art that some point mutations of amino acids may be more common than others. For example, glutamate is often seen to be substituted for glutamine, and asparate for asparagine. Consequently, when a small set of common modifications is considered, the number of possible modifications of a given peptide in a peptide database may be relatively small. For example, the average peptide with a molecular weight between 600 and 2,000 daltons may have approximately two phosphorylation sites. By this calculation, adding singly-phosphorylated peptide variants to a peptide database will increase its size by a factor of 3.

Experimental evidence indicates that three specific modifications account for a significant number of modified peptides measured in tandem mass spectrometers. These modifications include: oxidation of methionine, mutation of glutamine to glutamate, and mutation of asparagine to aspartate. For a selected peptide database, it has been calculated that adding variant peptides incorporating these three classes of modification may increase the database's size by 40% to 150%. It is important to note however, that the size of the index table is largely invariant relative to the size of the peptide database used to generate it (e.g. the larger peptide database does not result in a significantly larger index table). Additionally, the speed of the search may not be significantly affected by the more heavily populated index table. Therefore, a modest increase in the calculation time of the index table can result in substantially improved sensitivity and selectivity of a peptide search without having a significant impact on searching speed.

Software Functionality for Designating Modified Peptides

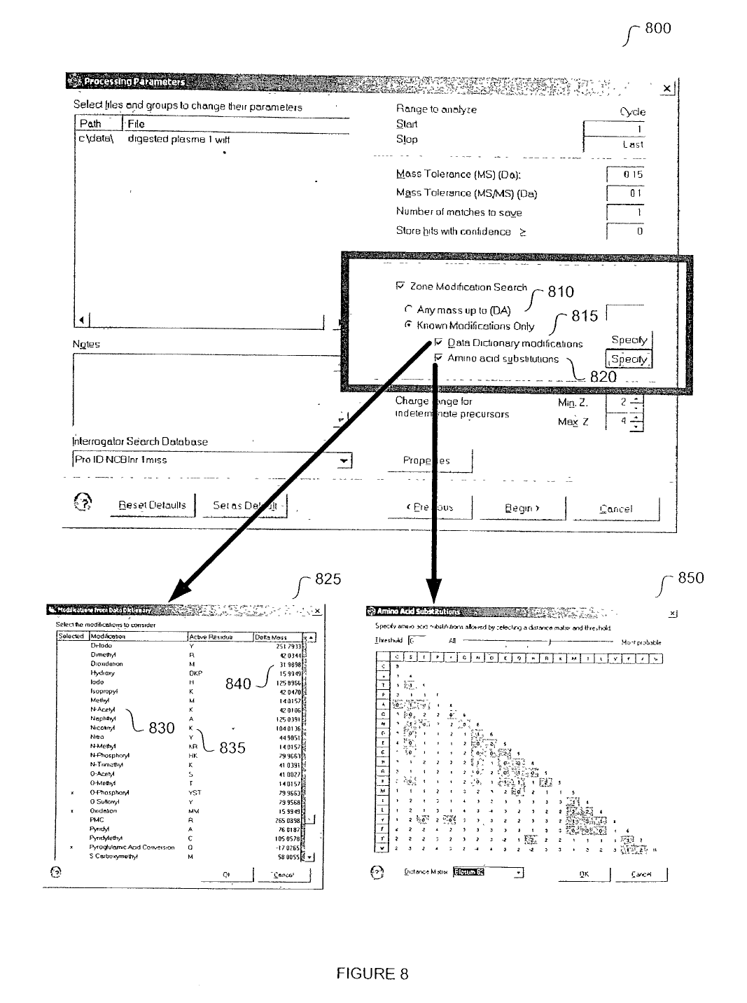

FIG. 8 illustrates an exemplary functionality for peptide modification designation in the analysis of peptide or protein samples embedded within a software program or application 800. As shown by way of illustration, modification designation may comprise selecting mass values according to selected mass or mass range 810. Additionally, modification designation may be performed according to selected chemical or functional group modifications 815. In one aspect, the modifications 815 may be selected from a plurality of available modifications stored in a modification database or modification dictionary 825. The modification dictionary 825 may comprise information describing the modification name 830, the location or amino acid residue which the modification affects 835, the approximate mass of the modification 840 and other information describing the characteristics or features of the modification.

As shown in FIG. 8, one or more modifications may be selected from the data dictionary 825 for parallel processing by the peptide identification methods described above. It will be appreciated that the illustrated chemical modifications represent but a small sampling of exemplary types and combinations of modifications that may be evaluated. Other types, compositions, and combinations of modifications should therefore be considered but other embodiments of the present teachings.

Another approach to modification selection may comprise selecting one or more amino acid substitutions 820 that may be evaluated in the context of the peptide or protein sample sequence. Modifications arising from amino acid substitutions 820 may be selected as specific substitutions (e.g. a particular amino acid substitution or a particular location) or as substitutions based on a range of amino acids and/or positions within the peptide or protein sample sequence. In one aspect, the selected substitution range may be based on events such as evolutionary probability and/or mutation prediction. Furthermore, as will be appreciated by one of skill in the art, the predicted amino acid substitutions may be identified using substitution matrices for sequence alignment such as, for example, the “BLOcks SUbstitution Matrix” or “Blosum” approach as well as the Gonnet matrix approach. In various embodiments, these substitution approaches evaluate the likelihood that amino acid residue compositions would mutate to each other in evolutionary time. An exemplary amino acid substitution matrix 850 may include the ability to specify amino acid substitutions allowed or desired within the query peptide. These substitutions may further include the ability to select substitutions located at a target distance from a particular amino acid or utilize a threshold approach to substitution assessment.

In various embodiments, peptide analysis hardware and software applications that integrate the methods described herein, yield accurate peptide identifications with a low observed error rates. For example, these methods may be integrated into software applications including the ICAT™, Pro ICAT™, Interrogator, BioAnalyst, and Pro ID peptide analysis applications (Applied Biosystems, CA) to provide improved identification of peptides in an automated manner using MS/MS spectra. Furthermore, the methods may be adapted for use with hardware systems including the API-QSTAR® Pulsar hybrid quadropole time-of-flight LC/MS/MS System (Applied Biosystems/MDS Sciex) and the Q TRAP™ LC/MS/MS System (Applied Biosystems/MDS Sciex) as well as other mass spectroscopy systems used in peptide identification.

Although the above-disclosed embodiments of the present teachings have shown, described, and pointed out the fundamental novel features of the invention as applied to the above-disclosed embodiments, it should be understood that various omissions, substitutions, and changes in the form of the detail of the devices, systems, and/or methods illustrated may be made by those skilled in the art without departing from the scope of the present teachings. Consequently, the scope of the invention should not be limited to the foregoing description, but should be defined by the appended claims.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

What is claimed is:

1. A method for determining the identity of a query peptide using a plurality of database peptides, the method comprising:
constructing an index table comprising a plurality of peptide mass values using masses obtained from the plurality of database peptides and backbone ion fragments thereof;
identifying a plurality of query mass values associated with the query peptide and one or more query peptide backbone fragments or ions;
identifying query mass values that correspond to masses contained in the index table and generating a plurality of comparison scores which reflect the correspondence between the query mass values and the masses contained in the index table; and
evaluating the comparison scores to identify at least one database peptide related to the query peptide based upon the greatest comparison score.

2. The method of claim 1, wherein peptide mass values for the database peptides are obtained by evaluating fragmentation spectrum or mass spectroscopy data.

3. The method of claim 2, wherein the fragmentation spectrum or mass spectroscopy data is generated using tandem mass spectrometry.

4. The method of claim 3, wherein tandem mass spectroscopy is performed by a method selected from the group consisting of: Fourier transform ion cyclotron resonance (“FTICR” ), quadrupole mass spectroscopy, ion trap mass spectroscopy, and time-of-flight mass spectroscopy.

5. The method of claim 1, wherein query mass values for the query peptide are obtained by evaluating fragmentation spectrum or mass spectroscopy data.

6. The method of claim 5, wherein the fragmentation spectrum or mass spectroscopy data is generated using tandem mass spectrometry.

7. The method of claim 6, wherein tandem mass spectroscopy is performed by a method selected from the group consisting of: Fourier transform ion cyclotron resonance (“FTICR” ), quadrupole mass spectroscopy, ion trap mass spectroscopy, and time-of-flight mass spectroscopy.

8. The method of claim 1, wherein the query mass values comprise primary mass values associated with a first ion composition and complementary mass values associated with a second ion composition.

9. The method of claim 8, wherein the first ion composition comprises b- ions and the second ion composition comprises y-ions.

10. The method of claim 1, further comprising performing a mass weighting operation in which masses contained in the index file are differentially weighted such that each mass contained in the index file reflects a desired contribution to the comparison score.

11. The method of claim 10, wherein differential weighting is used to favor selected peptide mass values that are more predictive of the composition of the query peptide than other peptide mass values.

12. The method of claim 11, wherein differential weighting is used to categorize the peptide mass values according to a peptide ion type.

13. The method of claim 12, wherein the peptide ion type comprises an ion selected from the group consisting of: y-ions, b-ions, a-ions, and immonium ions.

14. The method of claim 12, wherein differential weighting is based upon whether the mass value reflects a primary or complementary peptide ion.

15. The method of claim 1, further comprising associating at least one modification with the query peptide and identifying query mass values that are resultant from the modification.

16. The method of claim 15, wherein query mass values that are resultant from the at least one modification are removed from the mass value analysis prior to generation of the comparison scores.

17. The method of claim 15, further comprising:
determining a modification mass associated with the at least one modification; and
subtracting the modification mass from the query mass values that are resultant from the modification prior to generation of the comparison scores.

18. The method of claim 1, further comprising:
associating at least one modification with one or more of the plurality of database peptides;
calculating a modified peptide mass value which takes into account the at least one modification within one or more of the plurality of database peptides; and
introducing the modified peptide mass values into the plurality of database peptides and the index table for subsequent evaluation against the query peptide mass values.

19. The method of claim 1, further comprising:
partitioning the plurality of query mass values into a plurality of mass value zones;
associating at least one modification with at least one query mass value in a selected zone; and
evaluating the query mass values in each mass value zone while excluding query mass values associated with the at least one modification.

20. A method for comparing a query peptide to a plurality of database peptides, the method comprising:
constructing an index table comprising a plurality of mass values for the database peptides and ion fragments thereof;
identifying a plurality of mass values associated with the query peptide and peptide fragments thereof;
comparing the plurality of mass values associated with the query peptide and peptide fragments thereof with the plurality of mass values for the database peptides and ion fragments thereof and assigning a mass score to each of the mass values associated with the query peptide based upon the similarity between the compared mass values; and
evaluating the mass scores to identify at least one comparison having the greatest mass score and associating the query peptide with the database peptide which resulted from the at least one comparison having the greatest mass score.

21. The method of claim 20, further comprising associating a weight with each mass score that reflects the predictive value of the mass score.

22. The method of claim 21, wherein the weight associated with each mass score is based upon the type of peptide ion from which the mass value was derived.

23. The method of claim 22, wherein the type of peptide ion comprises an ion selected from the group consisting of: y-ions, b-ions, a-ions, and immonium ions.

24. The method of claim 21, wherein the weight is based upon whether the mass value reflects a primary or complementary peptide ion.

25. The method of claim 20, further comprising associating at least one modification with the query peptide and identifying query mass values that are resultant from the modification.

26. The method of claim 25, wherein query mass values that are resultant from the modification are removed from the mass value analysis prior to generation of the mass scores.

27. The method of claim 25, further comprising:
determining a modification mass associated with the at least one modification; and
subtracting the modification mass from the query mass values that are resultant from the modification prior to generation of the mass scores.

28. The method of claim 20, further comprising: associating at least one modification within one or more of the plurality of database peptides;
calculating a modified peptide mass value which takes into account the at least one modification with one or more of the plurality of database peptides, and
introducing the modified peptide mass values into the index table for subsequent evaluation against the query peptide mass values.

29. A method for comparing a modified query peptide to a plurality of database peptides, the method comprising:
generating a plurality of query mass values for the query peptide;
generating a plurality of database mass values associated with the plurality of database peptides;
identifying a modified set of query mass values from the plurality of query mass values wherein the modified set of query mass values correspond to mass values that reflect a modification to the query peptide;
excluding the modified set of query mass values from the plurality of query mass values, and
performing a comparison search which compares the plurality of query mass values to the plurality of database mass values to thereby associate the query peptide with at least one database peptide.

30. A method for comparing a modified query peptide to a plurality of database peptides, the method comprising:
generating a plurality of query mass values for the query peptide;
generating a plurality of database mass values associated with the plurality of database peptides;
identifying a modified set of query mass values from the plurality of query mass values wherein the modified set of query mass values correspond to mass values that reflect a modification to the query peptide;
adjusting the plurality of query mass values associated with the modified set of query mass values to account for mass differences resulting from the modification to the query peptide, and
performing a comparison search which compares the plurality of adjusted query mass values to the plurality of database mass values to thereby associate the query peptide with at least one database peptide.

31. A method for comparing a query peptide to a plurality of database peptides, the method comprising:
constructing an index table comprising a plurality of database mass values associated with fragmentation spectra for the database peptides;
identifying a plurality of query mass values associated with a fragmentation spectrum for the query peptide;
identifying at least one modification associated with at least one of the plurality of query mass values;
compensating for the at least one modification associated with at least one of the plurality of query mass values thereby generating a plurality of compensated query mass values; and
performing a search of the index table using the compensated query mass values,
identifying the composition of the query peptide based on similarities between the compensated query mass values and the database mass values.

32. The method of claim 31, wherein compensating for the at least one modification comprises excluding query mass values associated with the modification from the plurality of compensated query mass values.

33. The method of claim 31, wherein compensating for the at least one modification comprises identifying the mass of the modification and subtracting the mass of the modification from query mass values associated with the modification.

34. The method of claim 31, wherein the identified modification comprises a modification selected from the group consisting of: a phosphorylation site modification, an oxidation site modification, and a substitution site modification.

35. The method of claim 34, wherein the phosphorylation site modification comprises phosphorylation of an amino acid selected from the group consisting of: serine, threonine, and tyrosine.

36. The method of claim 34, wherein the oxidation site modification comprises an oxidation of an amino acid selected from the group consisting of: cysteine and methionine.

37. The method of claim 34, wherein the substitution site modification comprises substitution of an amino acid selected from the group consisting of: glutamine, glutamate, asparagine, and aspartate.

38. A method for peptide analysis comprising:
acquiring fragmentation spectra for at least one query peptide of unknown composition and a plurality of database peptides of known composition wherein each fragmentation spectrum comprises a plurality of mass values associated with a plurality of peptide fragments which are identified over a selected mass range;
identifying at least one modification associated with the at least one query peptide;
identifying mass values affected by the modification by evaluating the fragmentation spectrum and determining the propagation of the modification throughout the plurality of mass values;
performing a mass search by comparing mass values for the query peptide against the mass values for the plurality of database peptides while compensating for those mass values affected by the modification; and
identifying the composition of the query peptide by association with one of the database peptides based upon the mass search that provides the best match between the mass values of the query peptide and the mass values of the database peptides.

39. The method of claim 38, wherein compensation for those mass values affected by the modification comprises excluding mass values affected by the modification from the mass search.

40. The method of claim 38, wherein compensation for those mass values affected by the modification comprises:
determining the mass of the modification; and
subtracting the mass of the modification from those mass values affected by the modification.

41. The method of claim 38, further comprising:
partitioning the fragmentation spectra into a plurality of zones defining discrete mass ranges;
performing separate mass searches for each of the plurality of zones.
